(19) United States
(12) Patent Application Publication
(10) Pub. No.: US 2003/0014291 A1
(43) Pub. Date: Jan. 16, 2003

(54) Methods, functional data, and systems for optimizing product factors

(75) Inventors: Sean Michael Kane, Jacksonville, FL (US); Timothy Eugene Munson, Milford, OH (US); Peter Szehao Hsi, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: THE PROCTER & GAMBLE COMPANY

(21) Appl. No.: 09/902,144

(22) Filed: Jul. 10, 2001

(51) Int. Cl. G06F 17/60

(52) U.S. Cl. 705/8

(57) ABSTRACT

A method of optimizing a product factor is provided wherein factors associated with a product are received. Moreover, all available shelf space sets which may be used to house the product are received and one factor to optimize is selected.

Furthermore, functional data for optimizing one factor associated with a product is presented wherein one or more factor data have categories, financial data, product identification, and shelf space set data are provided. Further, constant value data is included where predetermined values/logical expressions are provided. Also, optimization instruction data is provided and operable to determine an optimal value for a selected factor data.

Moreover, a system for optimizing product placement on store shelves is provided comprising a data collection set of executable instructions operable to collect factor data and a constraint set of executable instructions operable to receive predetermined values associated with the factor data. Further, an optimizing set of executable instructions is operable to calculate an optimal value for at least one factor data.

### TECHNICAL FIELD

The present invention relates generally to methods, functional data, and systems used to optimize product factors associated with a product.

### BACKGROUND OF THE INVENTION

Linear programming or matrix algebra provides a variety of deterministic approaches used to solve complex computational problems when maximization or minimization of multiple values contained within a complex problem are desired. Optimal values are sought for a linear function subject to linear constraints.

It is well established in the art that these standard mathematical algorithms may be used in standard software applications for the purposes of generating results associated with multiple variables, the results may be further associated with user defined scenarios, in an attempt to optimize a particular value for a specific problem. Optimization may include minimizing or maximizing a particular value. And, the generated linear function from these algorithms, which will reproduce the optimal value, is often referred to as the cost or objective function.

Using known linear programming techniques within the retail industry as it applies to particular products or categories of products would be extremely advantageous to manufacturers, distributors, suppliers, and retailers of products. These techniques will more scientifically permit the industry to predict and optimize sales, customer loyalty programs, profit, and the like for a particular product or product category.

Moreover, factor or attribute data associated with products or categories of products are commonplace. Moreover, the data is collected, culled, associated, or otherwise assigned by retail stores, manufacturers, distributors, suppliers, and others. The data collected is used in a variety of ways in an attempt to improve sales of products. More particularly, a retail store, by way of example only, may attempt to maximize sales of a specific product by analyzing historical factor data associated with the sales of the product. This data once analyzed or mined may reveal that sales of the product increase during a particular month of the year, or that sales of the product are unusually high in a certain geographic/demographic area of the country.

Furthermore, often the data collection process is disparate among all the interested parties associated with the product. For example, a retail establishment may collect sales associated with a category of products (e.g., beauty care or laundry detergents), rather, then sales associated with a particular product (e.g., Tide®). Moreover,the data collected may not be centralized and may often be considered highly confidential, which results in the data not being shared among all the interested parties.

As a result, the collection and assignment of factor data, associated with a specific product, are extremely disparate and proprietary. This lack of uniformity and lack of openness within the industry has stymied all the interested parties in their individual abilities to truly maximize their own individual interests in the products being marketed.

This is particularly more noticeable today, since the data collection process has largely become electronic with data being instantaneously collected as a consumer makes a purchase at a retail store. Consider, by way of example only, a consumer entering a grocery store who purchases Tide®, the grocery store scans the bar code affixed to the packaging of Tide®, and the store is instantaneously and electronically capable of debiting the store's present inventory of Tide®. Moreover, the store is capable of associating a sale with the Tide® product, along with any coupon used by the consumer, date purchased, specific size or type of Tide® product purchased, and assuming the store has a loyalty program (e.g., loyalty cards which are also recorded by manually typing/optically scanning/magnetically swiping during a purchase), the store can associate the purchase with a specific customer (e.g., this may also be collected by a financial institution if the consumer pays by credit or debit card, although this data is not often shared with the manufacturers, distributors, suppliers, or retailers).

Additionally, one factor or attribute which retail stores are continually trying to optimize is the shelf space which will be made available to a particular product or category of products. Shelf space is a significant factor or attribute within the retail establishment, since available shelf space is scarce and a variety of products and category of products must be displayed and sold. Ideally, the retail store would like the ability to accurately predict how increasing or decreasing a predetermined shelf space size set (e.g., 10 linear feet, 15 linear feet, 20 linear feet, and the like), which is associated with a product or product category, will affect the retail store's sales of that particular product, product category, or make the store more profitable with respect to the arrangement of all products within the store given the store's limited shelf space. This will also affect the inventories of various products which the retail store may maintain and order on an ongoing basis.

Further, if manufacturers, distributors, or suppliers knew that an increase in shelf space for their particular product within a specific retail establishment would increase sales and profitability, then this shelf space information could be presented to the retailer to negotiate better deals/arrangements between the parties and improve the profitability of all interested parties.

As is apparent there is a need to combine a multiplicity of factor or attribute data associated with a product (e.g., especially shelf space factor data within a retail establishment) with linear programming to provide methods, functional data, and systems which optimize product sales, profitability, consumer loyalty, and the like.

### SUMMARY OF THE INVENTION

A graphical user interface (“GUI”), text user interface (“TUI”), DOS user interface (“DUI”), or any other electronic or automated user interface maybe used, wherein a user may select factor data associated with a product or a product category, with the factor data including a shelf space set associated with a predetermined amount of space which the product will occupy within a store. The user may select various factors which are to be constrained as well as a factor which is to be optimized using the interface.

The interface then interacts with standard linear programming algorithms embodied in software applications, well known to those skilled in the art, to optimize the factors selected by the user, based on the constraints associated with the factors and any pre-assigned/constant values associated with the factors. Once the optimal value is determined that value may be reported or delivered to the user via the original interface, via any other electronic media (e.g., print, facsimile, browser, voice, and the like), or via any other electronic application (e.g., word processor, spreadsheet, customized application, database application, browser application, and the like).

Accordingly, aspects of the invention are to provide methods, functional data, and systems for optimizing factors associated with a retail product. Additional aspects, advantages and novel features of the invention will be set forth in the description that follows and, in part, will become apparent to those skilled in the art upon examining or practicing the invention. The aspects and advantages of the invention may be realized and obtained by means of the instrumentalities and combinations particularly pointed out in the appended claims.

In one aspect of the invention, a method of optimizing one factor associated with a product is provided having executable instructions including receiving factors associated with a product. Moreover, a plurality of available shelf space sets to house the products are received and one factor is selected for optimization.

In yet another aspect of the present invention, functional data for optimizing one factor associated with a product is provided having one or more factor data including categories, financial data, product identification, and shelf space set. Further, constant value data is provided for one or more of the factor data along with optimizing instruction data operable to determine an optimal value for a selected factor data.

Another aspect of the invention is a system to optimize the use of existing shelf space within a store comprising a data collection set of executable instructions operable to collect factor data including available shelf space, product identifications, product categories, and financial data associated with the product identifications. A constraint set of executable instructions is operable to receive predetermined values associated with the factor data and an optimizing set of executable instructions is operable to calculate an optimal value for at least one of the factor data not predetermined.

Still other aspects of the present invention will become apparent to those skilled in the art from the following description of a preferred embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 illustrates a method of optimizing a product factor;

FIG. 2 illustrates functional data used to optimize a product factor; and

FIG. 3 illustrates a system to optimize the use of shelf space in a store.

Reference will now be made to the present preferred embodiment of the invention, an example of which is illustrated in the accompanying drawings, wherein like numerals indicate the same element throughout the views.

### DETAILED DESCRIPTION

The present invention provides methods, functional data, and systems for optimizing product factors. One embodiment of the present invention is implemented in the WINDOWS operating system, utilizing a MICROSOFT ACCESS database for data storage and retrieval, a customized GUI written in the Visual Basic programming language for interfacing with a user with the capability of collecting data via an import process from a MICROSOFT EXCEL spreadsheet, a report generation application provided by CRYSTAL REPORTS, and a linear programming application provided by FRONTLINE SYSTEMS. Of course other operating systems, databases or flat files, interfaces, programming languages, spreadsheet applications, report applications, and linear programming applications (now known or hereafter developed) may also readily employed all without departing from the present invention.

Furthermore, although linear programming and matrix algebra are used, by way of example only, to demonstrate how off-the-shelf math algorithms, well known in the industry, may be used to optimize factors associated with a product, it will be readily apparent to those skilled in the art that any form of mathematical algorithm may be used to optimize product factors without departing from the present invention. For example, software algorithms may be deployed with the present invention embodying mathematical algorithms using non-linear or quadratic techniques, simultaneous equation techniques, other non linear optimization techniques, and the like.

Data collection with respect to relevant data associated with a retail product or product category may originate from a multiplicity of entities, such as and by way of example only manufacturers, distributors, suppliers, retailers, taxing authorities, industry organizations, and others.

The specific relevant data is referred to herein as factor data and may include by way of example only, product identification, product categories, gross margin associated with the sales of the product, sales associated with the product, return on investment associated with the product, inventory associated with the product, profit associated with the product, expense associated with the product, other financial data, store aisle identification, shelf space within a particular retail store, and the like.

Store shelf space may include available linear or square feet within a store to house or display a product. Although as one skilled in the art will appreciate, the space may actually refer to a virtual store and the pixel dimensions available on a browser page to include information, images, audio, or video relative to the product. Additionally, shelf space need not be associated with a shelf, as floor space, outdoor space, advertisement space on various media (e.g., print, television, and the like), space on an electronic page, or any visual space which can house either physically or virtually a product may be shelf space for purposes of the present application.

Further, shelf space is more readily manageable when defined in terms of sets, such as and by way of example only, a set having 15 linear feet, 30 linear feet, and the like. Typically, traditional retail stores, which include grocery stores and the like, will have defined shelf space sets for various products, as well as, sales and financial data associated with the products. Once this shelf space set is combined with the various other factor data associated with a product, or a category of products, then the factors may be optimized using traditional linear programming techniques.

As one skilled in the art will readily appreciate, data collection from originators may be captured in a variety of electronic structures and formats and used in connection with an interface to permit a user the opportunity to import factor data, set constraints, and select a factor to optimize. Once defined, a linear programming application, such as and by way of example only one provided by FRONTLINE TECHNOLOGIES, may be used to select a discrete value for the factor to be optimized. This factor may then be communicated via an interface to the user. Although as previously presented, any mathematical optimization technique may be readily integrated without departing from the present invention.

Consider by way of example only, a retail grocery store X, having logically and physically structurally decomposed the layout of the store into hierarchical space sets, each set having a definable amount of space associated with a specific node within the hierarchy. The root node would be Store X, under that there may be first level nodes of Health and Beauty Care (“HBC”), Baby Care, Deli, Bakery, Dairy, Pet Food, Beverages, and others. After the first level of the hierarchy there may be a second, finer grain, level within the hierarchy, for example under HBC, there may be second level nodes of Health, Beauty, and others.

Under the second level a third level may exist for each second level node, for example Beauty may include third level nodes of Shampoo, Conditioner, and others. For each third level, there may be a fourth level which defines a specific product, for example for the Shampoo third level there may be fourth level entries of Head and Shoulders®, Physique®, Vidal Sassoon®, and others.

The logical structure of the grocery store X, is meticulously maintained and is easily molded within an electronic interface, such as a GUI, implemented as a stand alone application, or within an application such as a web browser. As will be readily apparent to those skilled in the art, each level of the hierarchy may actually itself be considered a product, in this way a product category and a product may be identical for purposes of analysis and optimization by the store. So, store X may optimize shelf space associated with Health Care, or Shampoo, or Physique®. Each product or product category will be associated with a specific definable shelf space.

Presently stores, such as store X in the present example, may be maintaining factor data and hierarchical data in spreadsheets, word processors, databases, and the like. In fact, financial factor data and shelf space data may actually be stored in separate electronic applications or locations by the store. This data may be integrated by accepting these various formats into a standard interface or permitting the interface to import this data from their existing formats. As one skilled in the art will appreciate this is a trivial tasks, and simple fielded GUI screens may be designed to query a user to input the various data already being collected by the store. Moreover, if the data in disparate applications have consistent fields for the data contained therein, such a spreadsheet or database application would, then importing these fields directly into a second interface would require only knowing the markup to identify the fields properly, this technique is well known and understood in the art.

Once a single interface has the factor data, a user may then be given the opportunity through the interface to create a scenario, wherein the scenario allows the user to constrain certain factors associated with a product or product category within a hierarchy and to optimize other a different factors associated with the product or product category.

Continuing with our present example, consider a user at store X who desires to maximize profits associated with Physique®, having already integrated the various financial and shelf space factor data, the interface presents the user with an edit scenario screen where various meta data associated with the created scenario may be entered by the user to later identify or modify the present scenario.

Some meta data associated with the scenario being created by the user may include a description, an electronic identification, a version attribute, a security attribute, an automatic adjust attribute (e.g., the scenario updates itself periodically or automatically as the factor data is modified or altered based on experience or adjustments associated with the financial data), date modified attribute, user name attribute, and others.

Next, the user is presented with a GUI with the Physique®'s factor data is displayed and listed as constraints, the user may respond to this screen by manually overriding constraints, such as and by way of example only, a shelf space attribute may be modified to be less than or equal to 80 linear feet and gross margin greater than $75,000. The non constrained factors (e.g. factors desired to be optimized) along with the constrained factors are then processed by standard linear programming techniques, well known to those skilled in the art, to produce an optimized result. Although, as will be readily apparent to those skilled in the art no factor need be constrained before optimizing a desired factor.

Results may be graphically displayed to the user as plain text in a text report format, or as a diagram such as and by way of example only a pie chart, bar chart, and others. Moreover, the results may be sent directly to a printer, to an email, to a website accessible via a link, to a facsimile, to a voice enabled server operable to convert text to voice and voice to text using XML technology, to television media, and to any other media or channel.

Clearly, the interface provided to the user allows for manual interaction with the user, but as one skilled in the art will readily appreciate, the interface may also interact automatically with other applications to perform operations in real time or in batch mode. In this way, reports may be generated at set period of times, such as the first day of each new month, or another application may cause reports to be run, such as when a new product is introduced, or when a product is removed and the space is reallocated within the store. In this way, the interface may provide direct user interaction, indirect user interaction, or interaction with a user that is itself an application (e.g. database triggers on updates of certain relevant factor data, and the like).

Additionally, the interface includes standard administrative features which permits the administrative user to establish authorized users, security levels, adjust hierarchies, product, product categories, shelf space sets, financial factor data, and any other factor data. Further, reports may even be customized, using standard reporting packages such as, and by way of example only, CRYSTAL REPORTS.

Also, filter applications may be introduced and made available to the user, filters may restrict or constrain results based on seasonal, occasional, geographical, destination, or other factors. Moreover, constraints may be removed from the evaluation. For example if a second level node in the hierarchy is desired to be optimized for a sales factor data, a specific, finer grain, third level category contained within the selected second level node may be excluded or held constant during the optimization calculation.

Furthermore, multiple hierarchies may be maintained such that one view of a hierarchy defines the products or product categories as defined above, whereas another view of a different hierarchy may depict the store by aisle or location. In this way, depending upon the hierarchy being used, an aisle within the store may be optimized for sales based on its factor data which would include products, product categories, financial factors, and the like.

Further, as will be apparent to those skilled in the art, the invention as presented herein which combines mathematical optimization algorithms, customized user/application interfaces, and database or data store access, need not be a stand alone application, rather, the application may be distributed, or centralized and made available through an Application Service Provider accessible via a web browser to an end user. Moreover, a single database is not required as the data present herein maybe stored in a variety of disparate databases, logically forming a data warehouse.

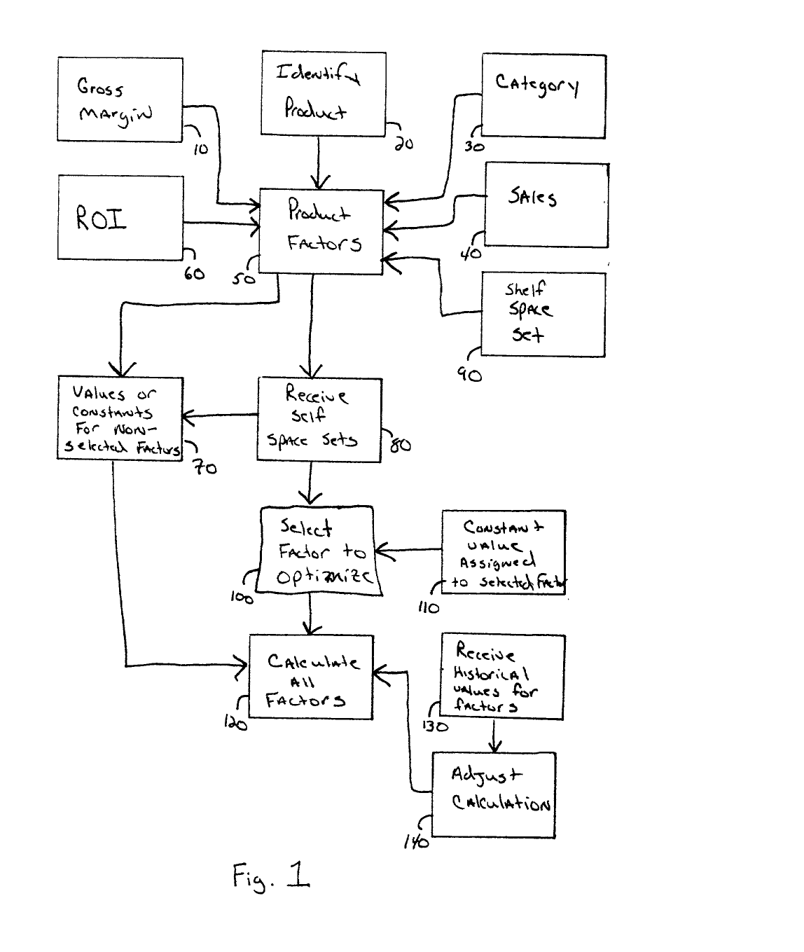

FIG. 1 depicts one method for optimizing a product factor, initially product factors are collected in step 50, these factors may include but are not limited to, product identification in step 20, gross margin associated with the product in step 10, return on investment associated with the product in step 60, sales associated with the product in step 40, a product category in step 30 which may or may not be associated with a hierarchy or hierarchical data, and various shelf space sets in step 90.

As previously presented, product factors may in fact be associated with product categories, and depending upon the optimization desired a product category may actually be equivalent to a product. For example, a store desiring to optimize Health Care may optimize on this coarse grain level of a hierarchy, rather, than identifying, a specific product within the Hair Care product category. Accordingly, in this example the product being optimized is the product category Health Care.

In step 80, various shelf space sets which may have been defined by the store and associated with the product or product category are received. As previously presented, these shelf space sets are discrete sets such that they are not modified unless by some administrative operation, and for purposes of optimization the sets are not extrapolated or interpolated. Although as one skilled in the art will readily appreciate integrating different mathematical optimizing algorithms may provide for extrapolation or interpolation to occur, all without departing from the present invention.

Next, a factor may be selected for optimization in step 100, alternatively or concurrently, values, constants, or logical constraining expressions may be assigned to the non selected factors in step 70.

Moreover, the factor to be optimized may itself be constrained or otherwise assigned the desired optimal value in step 110. In this situation the remaining factors will be optimally resolved based on the desired optimal value for the selected factor. The selected factor to optimize along with any and all constraining factors are then passed to a linear programming application which uses standard matrix algebra to iterate and calculate in step 120 the values of all factors.

Periodically, the calculation in step 120 may be adjusted in step 140 by receipt of modified historical values or modified values associated with the factor data in step 130. As one skilled in the art will readily appreciate, as a store begins to collect factor data and receive other types of factor data from other interested parties, such as and by way of example only, manufacturers, distributors, suppliers, and others, the quality of the calculation resolving the values of the factors presented in a scenario by a user will be improved.

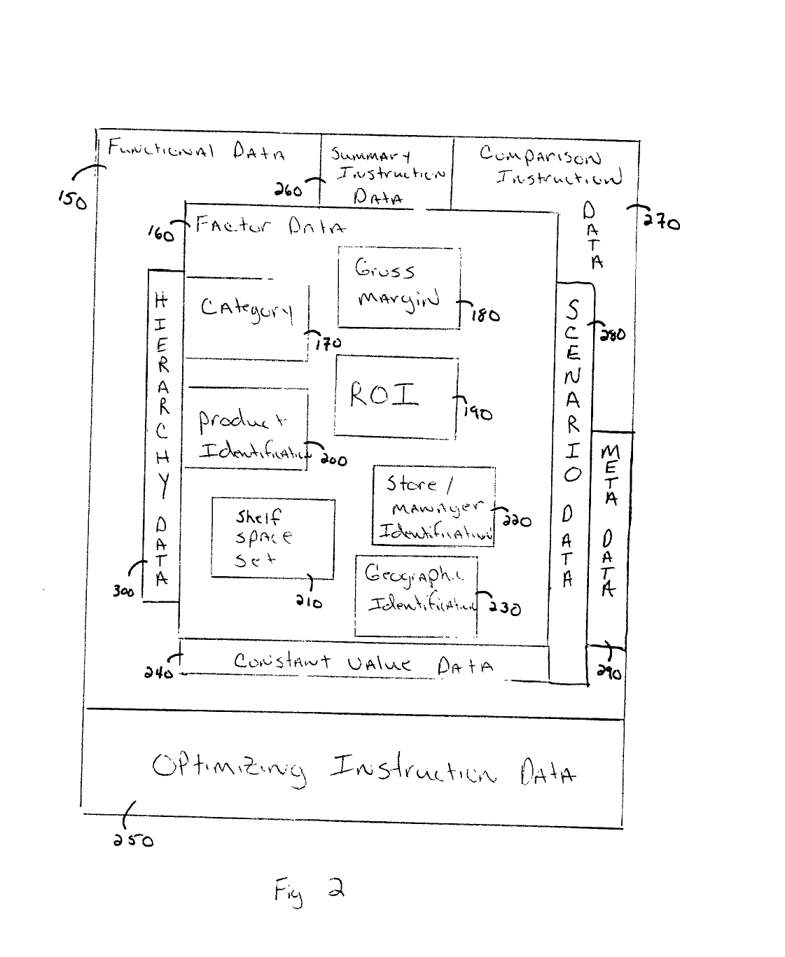

FIG. 2 depicts one view of functional data which may be used to optimize a product factor. Functional data 150 may be embodied within any computer readable medium, and although the functional data is depicted as being contiguous and as a single unit, one skilled in the art will readily appreciate that this is only for purposes of illustration only, since clearly the functional data may be distributed and logically associated or assembled using executable instructions executing on one or more computing devices.

Functional data 150 includes one or more factor data 160 including categories 170, product identification data 200, gross margin data 180, return on investment data 190, shelf space set data 210, store or manager identification data 220, and geographical identification data 230.

Furthermore, the functional data 150 includes constant value data 240 wherein a predetermined value one or more of the factor data 160 is known for any given scenario data 280. Moreover, the functional data 150 includes optimizing instruction data 250 operable, using standard matrix algebra to determine an optimal value for a selected factor data 160.

Additionally, product identification data 200 and category data 170 may be associated with hierarchical data 300, such that one or more categories 170 are associated with one or more product identification data 200 to form a hierarchy. The optimization instruction data 250 may then be used to optimize factor data 160 not having a predetermined value at any level of granularity associated with the logical hierarchy.

Further, scenario data 280 is formed once the constant value data 240 has received or knows the values of one or more of the factors and receives a factor which is to be optimized. Scenario data 280 may be associated with meta data 290 which is used to uniquely identify and provide descriptive information to a user or application about a specific scenario data 280. Meta data 290 may include a scenario identification, a scenario update date, a scenario create date, and owner identification, a security level and any other descriptive data.

Summary category instruction data 260 is operable to be used to report historical data associated with the factor data 160 or the scenario data 280. Moreover, comparison instruction data 270 is operable to be used to report on comparisons between one or more hypothetical sets of constant value data 240 (e.g., different scenarios) by using the optimizing instruction data 250 to generate a scenario optimal value for each hypothetical set.

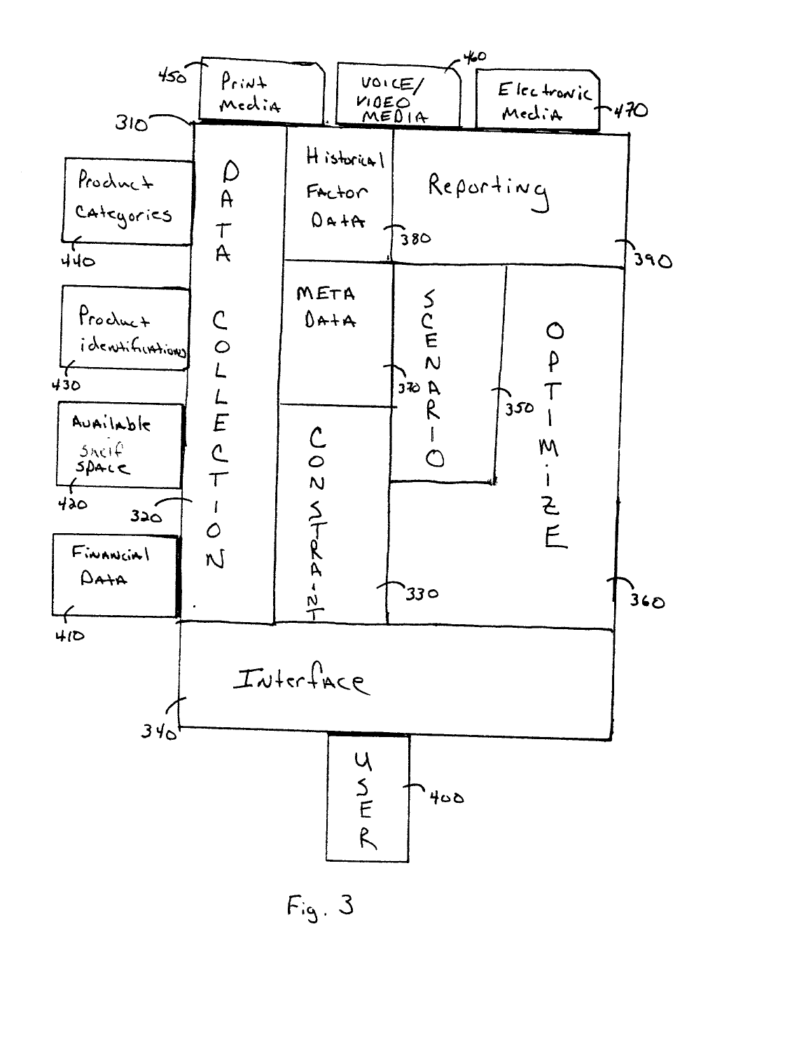

FIG. 3 depicts one system to optimize the use of shelf space in a store. The system 310 includes a data collection set of executable instructions 320 operable to collect factor data including available shelf space 420, product identifications 430, product categories 440, and any type of desired financial data 410. The factor data is associated with product identifications 430 and product categories 430. Moreover, the system 310 includes a constraint set of executable instructions 330 operable to receive predetermined values associated with the factor data 410-440. Further, the system 310 includes an optimizing set of executable instructions 360 operable to calculate an optimal value for at least one of the factor data 410-440.

A predetermined value does not imply that a specific/constant value is necessary, as any constraining logical expression is intended to be included within the phrase “predetermined value” for purposes of the present invention. Moreover, the factor to be optimized may itself be constrained in some way, if desired by the user.

An interface set of executable instructions 340 is operable to graphically display factor data to a user 400. As previously presented a user 400, may in fact be an application and not a person interacting with a computing device using an input device to instruct the interface set of executable instructions 340 to take some action. Also, as one skilled in the art will readily appreciate, the interface set of executable instructions 340 need not be graphical, as it may be TUI, DUI, or a voice interface using voice to text and text to voice technology with interaction documents encoded in voice enabled XML. The interface set of executable instructions 340 interacts with a user 400 to cause the constraint set of executable instructions 330 to receive constraining values, logical expressions, or predetermined values for the factor data 410-440, as desired by the user.

The combination of predetermined values assigned by the user 400 through the interface set of executable instructions 340, using the constraint set of executable instructions 330, produces a scenario which is used by the scenario set of executable instructions 350. The scenario set of executable instructions 350 is operable to produce one or more scenarios and uniquely identify, retrieve, and update, scenarios as needed.

A reporting set of executable instructions 390 collects historical factor data 380, which may exist within existing legacy scenarios or which may be created by any present scenario being constructed by a user 400. The reporting set of executable instructions may also render the historical factor data 380 to a variety of electronic media or channels, such as and by way of example only, print media 450, voice/video media 460, and any other electronic media 470 (e.g. electronic mail, web links, and others). Moreover, the reporting set of executable instructions 390 may render the historical factor data 380 directly to the user 400 through the interface set of executable instructions 340.

Furthermore, a meta data collection set of executable instructions 370 collects information regarding the versioning, updating, creating, security, description, and the like about each scenario generated by the scenario set of executable instructions 350. In this way, a user 400 may track, retrieve, update, and record scenarios with greater ease of use.

Finally, as will be apparent to those skilled in the art the data collection set of executable instructions 320 may be configured to dynamically collect factor data 410-440, such as and by way of example only when a sale occurs at a store and a the dynamically collected data may be inputted directly into the optimizing set of executable instructions 360 to improve calculations for desired factors in scenarios presented by the user 400 through the interface set of executable instructions 340.

The foregoing description of an exemplary embodiment of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the attached claims.

What is claimed:

1. A method of optimizing one factor associated with a product, having executable instructions comprising:
receiving factors associated with a product;
receiving a plurality of available shelf space sets to house the product; and
selecting one factor to optimize.

2. The method of claim 1, further comprising:
calculating a value of the one factor optimized based on the other factors.

3. The method of claim 1, further comprising:
receiving values for each factor not being optimized.

4. The method of claim 1, further comprising:
receiving a constrained value of the one factor to optimize.

5. The method of claim 4, further comprising:
calculating one or more values for the other factors based on the received constrained value.

6. The method of claim 5, further comprising:
using historical values for the other factors to modify the calculation.

7. The method of claim 1, where in the shelf space sets are received via a graphical user interface.

8. Functional data for optimizing one factor associated with a product, the functional data comprising:
one or more factor data including categories, financial data, product identification, and shelf space set;
constant value data wherein a predetermined value for one or more of the factor data is known; and
optimizing instruction data operable to determine an optimal value for a factor data selected for optimization.

9. The data of claim 8, further comprising:
hierarchical data operable to associate one or more of the categories and the product identification into a hierarchy.

10. The data of claim 9, further comprising:
scenario data operable to receive one or more hypothetical sets of constant value data and using the optimizing instruction data to generate a scenario optimal value for each hypothetical set.

11. The data of claim 10, further comprising:
meta data associated with the scenario data and including a scenario identification, a scenario update date, a scenario create date, an owner identification, a security level, and descriptive data.

12. The data of claim 8 wherein the factor data is imported from an electronic application or data file.

13. The data of claim 8 wherein the factor data is inputted by a user using a graphical user interface.

14. The data of claim 8, further comprising:
summary category instruction data operable to be used to report historical data associated with the factor data.

15. The data of claim 8, further comprising:
comparison scenario instruction data operable to be used to report comparisons between one or more hypothetical sets of constant value data by using the optimizing instruction data to generate a scenario optimal value for each hypothetical set.

16. The data of claim 8, wherein the factor data further includes a store identification, a geographical identification, and a manager identification.

17. A system to optimize the use of existing shelf space within a store, comprising:
a data collection set of executable instructions operable to collect factor data including available shelf space, product identifications, product categories, and financial data associated with the product identifications and the product categories;
a constraint set of executable instructions operable to receive predetermined values associated with the factor data; and
an optimizing set of executable instructions operable to calculate an optimal value for at least one of the factor data.

18. The system of claim 17, further comprising:
an interface set of executable instructions operable to graphically display the factor data to a user.

19. The system of claim 18, wherein the interface set of executable instructions are operable to receive one or more of the predetermined values from the user and provide the received predetermined values to the constraint set of executable instructions.

20. The system of claim 17, further comprising:
a scenario set of executable instructions operable to execute the constraint set of executable instructions and the optimizing set of executable instructions one or more times to produce one or more scenarios.

21. The system of claim 20, further comprising:
a reporting set of executable instructions operable to collect historical factor data and render the historical factor data in print, voice, or electronic media.

22. The system of claim 21, further comprising:
a meta data collection set of executable instructions operable to collect information regarding the versioning, updating, creating, or security of the scenarios.

23. The system of claim 17, wherein the data collection set of executable instructions collects at least a portion of the factor data dynamically as a sale occurs within a store.

24. The system of claim 23, wherein the dynamically collected factor data is used to adjust the optimizing set of executable instructions to provide an improved optimal value.
